(19) United States
(12) Patent Application Publication
(10) Pub. No.: US 2026/0180658 A1
(43) Pub. Date: Jun. 25, 2026

(54) INCREASING SPEED OF FTM MEASUREMENTS

(71) Applicant: HEWLETT PACKARD ENTERPRISE DEVELOPMENT LP, Spring, TX (US)

(72) Inventors: JUNPENG WU, Beijing (CN); ZHONGLIN FENG, Beijing (CN); SACHIN GANU, Santa Clara, CA (US); VIKRAM RAGHU, Santa Clara, CA (US); MATHIEU MERCIER, St. Laurent (CA); DENIS HOULE, St. Laurent (CA); OMAR EL FERKOUSS, St. Laurent (CA)

(21) Appl. No.: 18/989,712

(22) Filed: Dec. 20, 2024

(51) Int. Cl. H04B 7/06; H04B 7/212; H04B 17/18

(52) U.S. Cl. CPC H04B 7/063; H04B 7/2121; H04B 17/18

(57) ABSTRACT

Systems and methods are provided for optimizing, e.g., speeding up, fine time measurement (FTM) scanning by dedicating a radio of a network element, such as an access point (AP), to performing FTM scanning at a high frequency. The high frequency FTM scanning provides quicker results regarding location determination of the network element as compared to conventional FTM scanning, which is performed merely as a background process. The high frequency FTM scanning can be performed in accordance with configurable FTM scan parameters.

### BACKGROUND

Wireless digital networks are becoming ubiquitous in enterprises, providing secure and cost-effective access to resources. Those networks usually have one or more controllers, each controller supporting a plurality of network devices or network elements, such as access points (AP) deployed through the enterprise. Wi-Fi networks operating in accordance with IEEE 802.11 standards are examples of such networks. Wireless network communications devices (also referred to as stations or client devices), such as personal computers and mobile phones transmit data across wireless digital networks vis-à-vis Wi-Fi APs, and cellular network APs, for example.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration in which examples of the disclosed technology may be implemented to effectuate improved fine time measurement (FTM) scanning or ranging.

FIG. 2 illustrates an example AP in which one or more radios may be dedicated to performing FTM scanning.

FIG. 3 is a message flow diagram illustrating various aspects of FTM scanning in accordance with one example of the disclosed technology.

FIG. 4 illustrates a computing component that may be used to implement optimized/improved FTM scanning in accordance with various examples of the disclosed technology

FIG. 5 illustrates a computing component that may be used to implement optimized/improved FTM scanning in accordance with various examples of the disclosed technology.

FIG. 6 depicts a block diagram of an example computer system in which various examples of the disclosed technology described herein may be implemented.

The figures are not exhaustive and do not limit the present disclosure to the precise form disclosed.

### DETAILED DESCRIPTION

As noted above, stations (STAs) or client devices, such as laptops, personal computers, smartphones, etc. may connect to network devices, such as APs, to exchange data with the network. Various techniques can be employed for determining the position/location of a device (e.g., STAs or APs) based on receiving wireless communication signals. For example, the Fine Timing Measurement (FTM) protocol (also referred to as 802.11MC or Round Trip Timing (RTT), provides a mechanism by which a distance between FTM-capable Wi-Fi entities, such as mobile devices, APs, etc., can be determined. As described below in greater detail, FTM sessions can be established between a client device and one or more APs, between two APs, etc.

FTM may allow a client device or AP to determine its distance from another AP by measuring the duration of a radio wave transmission time frame traveling back and forth between the client device and the AP, or the AP and another AP, e.g., time of arrival (TOA), the RTT, or the time difference of arrival (TDOA) of wireless communication signals. For example, to measure the distance between a client device and an AP using FTM, the client device may send a ranging request to the AP to initiate an FTM session. In the FTM session, an exchange of FTM messages occurs between the client device and the AP based on which distance between them is estimated. The AP receiving the ranging request allocates its computing resources and time slots for handling the FTM message exchanges in the FTM session.

However, as more ranging requests are received by the AP, more computing resources and a greater number of time slots of the AP may be consumed, which in turn may increase the processing load of the AP. For example, in a large cluster of APs, measurements can take upwards of 12 hours to obtain, where FTM scanning is typically performed in the background/as a background AP process. Accordingly, the traffic handling performance of the AP can be adversely affected, as well as the APs' ability to handle the ranging requests, perform background scanning for other packet types, etc. Consider, for example, a new enterprise deployment comprising a plurality of APs that have been newly deployed. A user or administrator may wish to determine the locations of the newly deployed APs. FTM scanning or ranging can be performed to obtain distances between the newly deployed APs. To ensure or help ensure that determined locations/obtained distances are as accurate as possible, relative AP distances should be measured between all or as many neighboring APs as is possible.

Thus, examples of the disclosed technology are directed to optimizing, e.g., increasing the speed/reducing impact of FTM scanning. A location service or location-requesting device can create an FTM session and send FTM scan parameters to a responding entity, e.g., an AP. The AP can put a particular radio into a dedicated operating mode whereby the radio is used solely (or almost exclusively) for FTM scanning on a specified channel. The scan parameters set forth rules/conditions/characteristics that aim to minimize scan times of neighboring entities, such as neighboring APs, ensure accuracy, and reduce the impact on network operations or communications. One scanning parameter sets forth: an ordered channel list according to which the dedicated radio performs its FTM scanning; a time when FTM scanning begins (e.g., to avoid high customer usage times); and a number of retry scans.

Examples of the disclosed technology can account for situations where, e.g., a channel on which FTM scanning is to occur is a Dynamic Frequency Selection (DFS) channel. In some examples, FTM scan operations can be customized using the specified FTM scan parameters in accordance with an algorithm that balances how much time is spent FTM scanning, and how much time an AP waits for FTM requests from neighboring APs, as well as using random time jitter to avoid having APs perform FTM scanning at the same time. Thus, efforts can be taken to balance the use of an AP's resources for FTM and non-FTM functions, such as providing enterprise services, servicing connected STAs, delivering high priority traffic, scanning the network, etc.

The IEEE 802.11 standards provide several distinct radio frequency (RF) ranges, such as 2.4 GHZ, 5 GHZ, and 6 GHz frequency bands, for use in WLAN communications. Each frequency band is divided into multiple channels. In some examples, the channels may have a channel width of 20 MHz, 40 MHz, 80 MHz, or 160 MHz. Channels with a wider channel width may provide a higher throughput. Generally, wireless enterprise deployments use 20 MHz or 40 MHz channel widths for operation, particularly in dense environments which may minimize interference, allow spatial reuse, enhance spectrum efficiency, and reduce any adverse impact on neighbor APs' performance. Using channels with 20 MHz or 40 MHz channel widths may also provide a greater number of channels and better coverage particularly in dense enterprise deployments. On the other hand, using a higher channel width (such as 80 MHz) enables an optimal FTM accuracy for location-based applications on indoor deployments. In some examples, FTM-based positioning techniques may exhibit less than one-meter precision error for channels with 80 MHz channel widths while they may exhibit higher error margins for channels with lower channel widths (such as 20 MHz or 40 MHz). Therefore, there is a need to optimize FTM accuracy on APs while having minimal impact on the network performance.

As used herein, the term “radio chain” can refer to hardware that can transmit and/or receive information via radio signals. Wireless client devices and/or other wireless devices can communicate with a network device on a communication channel using multiple radio chains. As used herein, the term “communication channel” (or channel) can refer to a frequency or frequency range utilized by a network device to communicate (e.g., transmit and/or receive) information. A radio chain can include two antennas such as a horizontal antenna and a vertical antenna, among other possibilities. As used herein, the term “antenna” refers to a device that converts electric power into radio waves, and/or vice versa.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

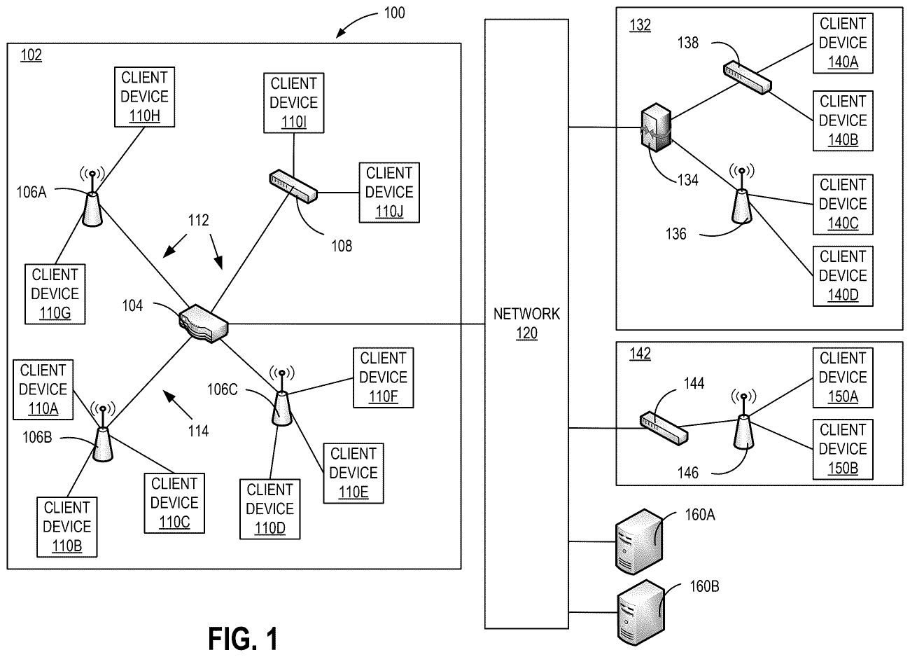

FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some embodiments, the controller 104 communicates with the network 120 through a router (not illustrated). In other embodiments, the controller 104 provides router functionality to the devices in the primary site 102.

A controller 104 may be operable to configure and manage network devices, such as at the primary site 102, and may also manage network devices at the remote sites 132, 142. The controller 104 may be operable to configure and/or manage switches, routers, APs, and/or client devices connected to a network. The controller 104 may itself be, or provide the functionality of, an AP.

The controller 104 may be in communication with one or more switches 108 and/or wireless APs 106A-C. Switches 108 and wireless APs 106A-C provide network connectivity to various client devices 110a-j. Using a connection to a switch 108 or AP 106A-C, a client device 110A-J may access network resources, including other devices on the (primary site 102) network and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IoT) devices, and the like.

Within the primary site 102, a switch 108 is included as one example of a point of access to the network established in primary site 102 for wired client devices 110I-J. Client devices 110I-J may connect to the switch 108 and through the switch 108, may be able to access other devices within the network configuration 100. The client devices 110I-J may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106A-C are included as another example of a point of access to the network established in primary site 102 for client devices 110A-H. Each of APs 106A-C may be a combination of hardware, software, and/or firmware that is configured to provide wireless network connectivity to wireless client devices 110A-H. In the illustrated example, APs 106A-C can be managed and configured by the controller 104. APs 106A-C communicate with the controller 104 and the network over connections 112, which may be either wired or wireless interfaces.

The network 120 may be a public or private network, such as the Internet, or other communication network to allow connectivity among the various sites 102, 132 to 142 as well as access to servers 160A-B. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities.

As can be appreciated, digital modernization is accelerating, and the use of location-aware/location-based services, e.g., turn-by-turn wayfinding, asset tracking, business analytics, smart office initiatives, and the like, is expanding. Thus, a need for determining the location of, e.g., a client device, such as client device 110J, exists. As also noted above, FTM may be used to determine the location of APs, in a deployment, e.g., to understand a network's topology, to optimize service/coverage, and so on. APs, such as APs 106A-C, can act as reference points from which client device (and other AP) measurements can be made. Hence, considering for example, that AP 106A is an AP that has radios capable of operating in the 2.4, 5, and 6 GHz bands, a location service such as a location-based application running on client device 110J may create an FTM session, and send FTM scan parameters to AP 106A in order to determine the geographical location of client device 110J. In accordance with another example, controller 104 may be in need of the location of APs 106A-C, e.g., to support some business logic. AP 106A may dedicate one of its radios to operating on a specified band (set forth in the FTM scan parameters) to perform FTM scanning between it and its neighboring APs, e.g., APs 106B and 106C. In the case of DFS channels, if a zero-wait-DFS function is enabled, AP 106A can monitor a next DFS channel if a channel list was provided. If the channel to which the dedicated radio has moved is a DFS channel, AP 106A can wait the requisite Channel Availability Check (CAC) time, or if AP 106A senses the existence of radar signals on the DFS channel, AP 106A can select a new channel, e.g., from the provided channel list, on which the dedicated radio may operate.

Upon commencing FTM scanning, AP 106A may begin responding to FTM request frames from a client device, e.g., client device 110J, or from another AP, e.g., a neighboring AP, such as AP 106B. To improve accuracy, client device 110J or AP 106B may send FTM request frames to multiple APs, e.g., AP 106B and AP 106C (in the case of client device 110J requesting ranging) or AP 106C (in the case of AP 106B requesting ranging), where APs 106B or 106C can also dedicate a radio(s) to communicating on a specified FTM scan channel, and respond to such FTM request frames. By dedicating a radio to FTM scanning operations, the AP no longer relegates FTM scanning to the background, increasing the speed at which FTM scanning can be performed. Moreover, the dedicated radio cannot be used by client devices, such as client devices 110A-J for communications purposes. If AP 106A, as noted above, dedicates its 6 GHz radio to FTM scanning, its 2.4 GHz radio can remain operational for network advertising, supporting client device communications, etc. FTM scanning can be coordinated amongst a cluster of APs, e.g., APs 106A, 106B, and 106C, by way of the same channel list being shared amongst APs 106A-C, and coordinating the timing of FTM scanning amongst APs 106A, 106B, and 106C such that APs 106A, 106B, and 106C perform FTM scanning on the same channel at approximately the same time.

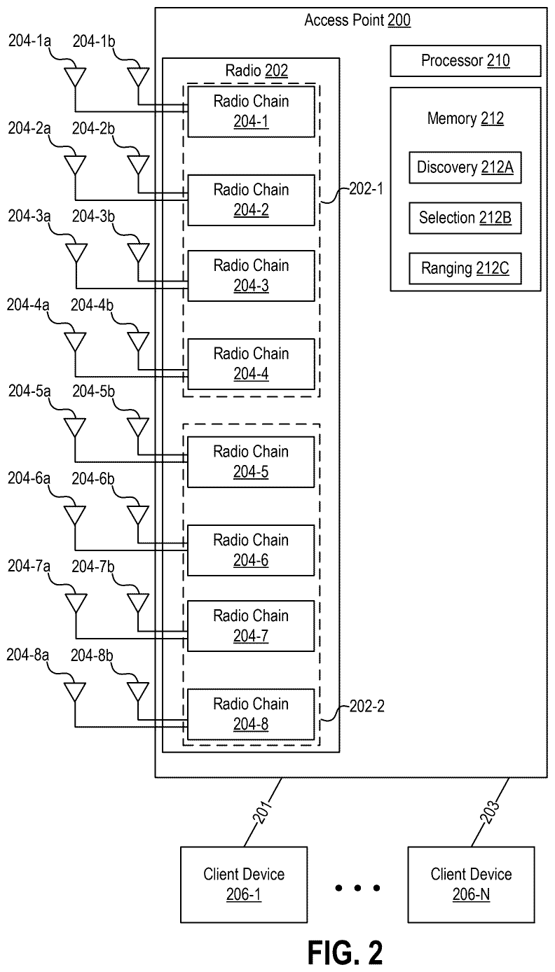

FIG. 2 illustrates an example AP 200, which may be an embodiment of one of the APs of FIG. 1 (e.g., APs 106A-C). An AP can refer to a networking device that allows a wireless client device to connect to a wired or wireless network, and need not necessarily be limited to IEEE 802.11-based APs. An AP can include a processing resource, e.g., processor 210, a memory, e.g., memory 212, and/or input/output interfaces (not shown), including wired network interfaces such as IEEE 802.3 Ethernet interfaces, as well as wireless network interfaces such as IEEE 802.11 Wi-Fi interfaces, although examples of the disclosure are not limited to such interfaces.

AP 200 can include a radio 202 which may be a 5 GHz radio including eight radio chains, 204-1, 204-2, 204-3, 204-4 . . . , 204-8. Each radio chain may include two antennas (204-1a, 204-1b. 204-2a, 204-2b, 204-3a, 204-3b, 204-4a, 204-4b . . . , 204-8a, 204-8b). For instance, each radio chain can include a horizontal antenna and a vertical antenna, among other possibilities. Each radio chain is available for both transmitting and receiving data. It should be understood that examples of the present disclosure are not so limited. Although not shown in FIG. 2 for clarity and so as not to obscure examples of the present disclosure, each of the radio chains can be connected to the plurality of antennas via a RF switch. As illustrated in FIG. 2, AP 200 can be configured to operate using two (dual-radio mode) or more radios. For example, radio 202-1 can be dedicated to a first communication channel 201 in the 5 GHz band (providing connectivity to client device 206-1), while radio 202-2 can be dedicated to a second communication channel 203 in the 6 GHz band (providing connectivity to client 206-N). In other examples, radio 202-1 can be dedicated to communications in the 6 GHz band, while radio 202-2 can be dedicated to communications in the 2.4 GHz band. It should be understood that while in some embodiments, the non-6 GHz radio can be either a 2.4 GHz radio or a 5 GHz radio, an AP can also comprise another 6 GHz radio that is operating on a primary scanning channel (PSC).

As can be appreciated, AP 200 has the ability to dedicate its radios (e.g., radios 202-1/202-2) to a particular channel (e.g., channels 201/203) when providing service or connectivity to client devices (e.g., client devices 206-1/206-N). In accordance with examples of the disclosed technology, an AP's radios may further be dedicated to a particular channel or set(s) of channels on which the AP's radios may perform FTM scanning. Following one of the above-noted examples, consider a scenario where radio 202-1 can be dedicated to performing FTM scans in the 6 GHz band, while radio 202-2 can be dedicated to supporting client device communications in the 2.4 GHz band. Dedicating radio 202-1, in accordance with examples of the disclosed technology, to a channel within the 6 GHz band for FTM scanning purposes allows radio 202-1 of AP 200 to be used only for FTM scanning, and not for providing client device connectivity. This can speed up FTM scanning (no longer being relegated to being a background scanning process), while still minimizing AP down time to client devices by providing connectivity over the 2.4 GHz band.

In some examples, a plurality of radios may be dedicated to FTM scanning operations. That is, radio 202-1 can be dedicated to a first communication channel 201 in the 5 GHz band for FTM scanning (instead of providing connectivity to client device 206-1, performing FTM scanning). Radio 202-2 can also be dedicated to a second communication channel 203 in the 6 GHz band for FTM scanning instead of providing connectivity to client 206-N. In this example scenario, FTM scanning can again be prioritized, but providing connectivity to client devices is temporarily halted. It should be understood that all or only some subset of an AP's radios may be dedicated to FTM scanning.

Traditionally, in any radio frequency (RF) zone of a deployment (that is, a zone in which multiple APs that may be able to detect each other have been installed or implemented), the APs are connected at the back-end, to a controller device that can aggregate the states of different APs and provide inputs to those different APs. In accordance with some examples, a deployment can refer to or can be defined as some plurality of basic service set IDs (BSSIDs) (which corresponds to cell size) across a given geographical area, e.g., office building, warehouse, etc. And again, an RF zone or simply zone can refer to a deployment subset comprising a plurality of APs that can hear, interfere with, and/or listen to each other. For example, a deployment may comprise a plurality of BSSIDs spread throughout a building having three stories, while a zone of the deployment may comprise one floor of the three stories.

In the example of FIG. 2, AP 200 may be configured (e.g., encoded with instructions executable by at least one processor 210) to send or receive communication signal(s) via communication path(s) (e.g., channels 201/203) to perform ranging during a beacon interval. Communication path(s) may include any suitable link(s) (e.g., wired or wireless, direct or indirect, etc.) between a network device, and one or more other network devices (e.g., APs), one or more client devices (e.g., communication devices), or a combination thereof. Memory 212 may include any suitable instructions for AP 200 to perform ranging during a beacon interval (e.g., to perform AP discovery instructions 212A, AP radio and channel selection instructions 212B, and ranging/scanning initiation instructions 212C).

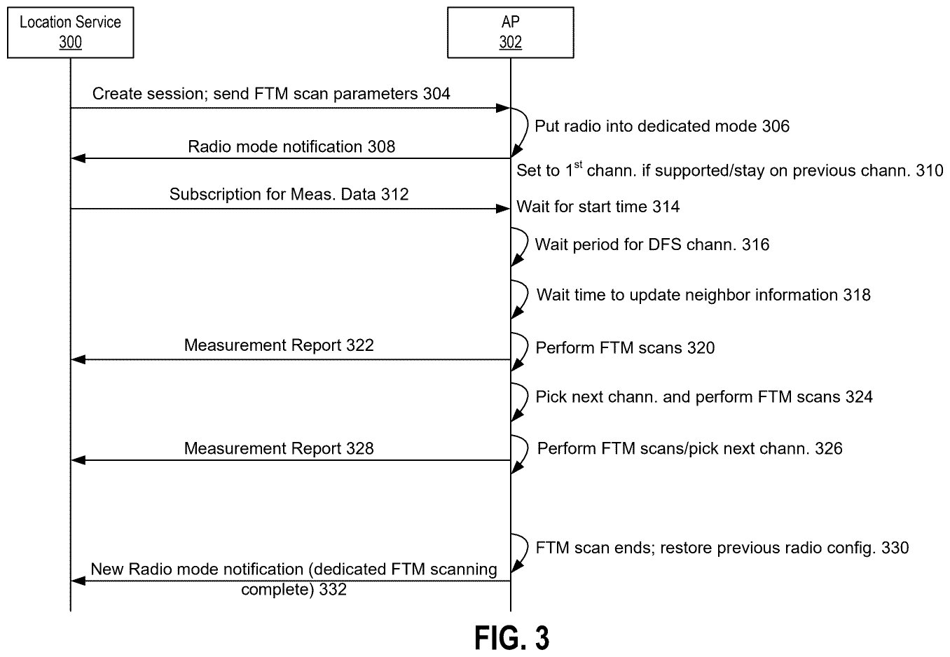

FIG. 3 is a message flow diagram illustrating various aspects of FTM scanning or taking FTM measurements in accordance with one example of the disclosed technology. As noted above, FTM scanning or ranging can be prompted by a need or desire to determine the location(s) of APs in a deployment or network, for example. That need may arise from a location service or application that operates pursuant to AP location information.

As illustrated in FIG. 3, a location service 300 may create an FTM session, and can send FTM scan parameters at operation 304. The location service 300 may be hosted or may be executed vis-à-vis a controller (such as controller 104 of FIG. 1). In some examples, the controller may be capable of performing all requisite operations, but in some examples, the controller may work in conjunction with one or more servers (local or remote/cloud-based), such as servers 160A/B of FIG. 1.

In creating an FTM session, location service 300, by way of the controller/server, may create a unique session ID to identify and distinguish, from one another, FTM (or other types of) sessions being controlled or managed by the controller/server. Scan parameters that are sent by location server 300 to AP 302 can include, but are not limited to the following parameters or characteristics: session ID; radio band (or radio ID); a channel list; channel-width, radio power; start time; neighbor update time; dwell time; scan duration; retry times; minimum neighbor scan times; and a channel list loop number.

The session ID can be any appropriate textual, numerical (or both) identifier assigned to or associated with the performance of FTM scanning (transmitting FTM scan requests and receiving/waiting to receive FTM responses across the channels specified in a received ordered channel list). That is, the example scenario illustrated in FIG. 3 represents a single session (identified by a session ID that is bound or associated with the location service 300 “action request”).

The radio band/ID can comprise an indication of one or more bands to which FTM scanning is limited. Location service 300 may specify a desired band over which FTM scanning is to be performed. Indicating this radio band in the scan parameters can inform AP 302 which of its radios to dedicate to FTM scanning, e.g., the 2.4 GHZ radio, the 6 GHz radio, etc.

The channel list can comprise some group/matrix/list of channels to which dedicated FTM scanning radios of an AP should tune when put in dedicated FTM mode (in accordance with the specified radio band/ID). In some examples, the controller/server can fetch a channel list that includes supported channels. The controller/server can fetch such a supported channel list from AP 302, other services that may already have/reference a supported channel list, AP/network configuration information, or regulatory information (e.g., specifying select channels on which a given AP may operate). In some examples, the controller or server (or other network device/entity) hosting location service 300 can calculate a best common channel list indicating those channels that are supported by the most/more APs. In some examples, the channel list may be an ordered channel list specifying one or more channels to which the dedicated radio(s) of AP 302 should tune to perform the FTM scanning. The order of the list may reflect a preferred sequence that the dedicated radio(s) of AP 203 should follow. The order in which the dedicated radio(s) of AP 302 should utilize channels to perform FTM scanning can reflect considerations such as time-of-day impact to channel usage, allowing all the dedicated radios to perform FTM scanning while on the same channel to avoid interference, and so on.

As discussed above, a frequency band (e.g., the 2.4 GHZ, 5 GHZ, or 6 GHz frequency band) can be divided into multiple channels. In some examples, the channels may have a channel width of 20 MHz, 40 MHz, 80 MHz, or 160 MHz. Channels with a wider channel width (e.g., 80 MHz or 160 MHz)) may provide a higher throughput. Channels with narrower channel width (e.g., 20 MHz or 40 MHz channel widths) may minimize interference, allow spatial reuse, enhance spectrum efficiency, and reduce any adverse impact on neighbor APs' performance. Thus, depending on whether narrower or wider channel widths may be more advantageous for performing FTM scans in a particular environment, during a particular period/time of day, etc., location service 300 can specify a desired channel width for use by the dedicated radios of AP 302.

Radio power can refer to the transmit power level(s) at which AP 302 should be operating, i.e., the strength of any signal, such as a beacon, sent out by the dedicated radio(s) of AP 302. Channel width and signal-to-noise ratio (or other metrics/characteristics) may impact at what power level the dedicated radio(s) of AP 302 should be operating. For example, in a densely populated deployment, the use of high transmit power levels may cause interference with other APs, and thus, location service 300 may make a determination to avoid such high transmit power levels. In other scenarios, higher power levels may be warranted in order to effectuate clear FTM message exchanges between location service 300 and AP 302.

Start time can refer to a time at which any dedicated radio(s) of an AP, such as AP 302, should begin performing FTM scanning. The start time for FTM scanning can be adjusted based on various considerations that can impact the quality of service provided by APs to client devices, times during which communications or management traffic between APs may be at their peak or at their minimum, and so on. For example, while FTM scanning is performed in the foreground using dedicated radios, FTM scanning can still impact client device's connections/system performance due to certain AP radios being dedicated to FTM scanning for a given duration. Accordingly, start times can be set to minimize the impact is has on the network, e.g., upon an AP first being deployed, after a group of APs boots up, during a period of low traffic (e.g., non-standard work hours in an office AP deployment).

A neighbor update time can refer to a period of time that an AP, such as AP 302, should wait to hear/listen for neighboring AP beacons or other packets in order to update its neighbor entry data (e.g., channel or bandwidth). For AP 302 to perform FTM scanning, AP 302 leverages this updated information to decide if a neighbor AP is on the same channel, and which channel bandwidth will be used for FTM scanning. Changes to its neighbor list may be determined based on the FTM scanning AP 302 performs between it and the other APs of the deployment in which AP 302 (and the other APs) are operating.

Dwell time can refer to an amount of time that an AP, e.g., AP 302, spends sending FTM scan requests to neighbor APs, and responding to FTM scan requests from its neighbor APs. It should be noted that an AP performs one of these actions at a time, e.g., an AP may send an FTM scan request during one period of time, and then may respond to a neighbor AP's FTM scan request during a subsequent period of time that the AP reserves for this purpose.

Scan duration can refer to another amount of time corresponding to the maximum amount of time that an AP, e.g., AP 302, waits for a neighbor AP to respond to an FTM scan request that the AP transmitted. If an AP does not receive a corresponding FTM response to the FTM scan request that it sent out, the AP will “end” the FTM scan request and no longer wait for a corresponding FTM response. Scan duration and dwell time, together, can be considered to balance the amount of time spent on sending FTM scan requests/waiting for FTM responses to/from neighboring APs, and the amount of time spent responding to FTM scan requests received from neighboring APs. It should be understood that in some examples, scan duration and dwell time can be considered to be a single, configurable FTM scan parameter.

Retry time can refer to a number of FTM scan attempts an AP, e.g., AP 302, makes during a particular FTM session/within the specified scan duration. For example, if AP 302 attempts to perform FTM scanning with a particular neighbor AP, but the FTM scanning attempt fails, the retry time parameter specifies the number of additional attempts AP 302 should make to perform FTM scanning.

The minimum neighbor scan time can refer to an FTM scan/counter threshold that can be used to track/count FTM scans or used as a fetched FTM scan results counter. More particularly, minimum neighbor scan time can be used to set a threshold number of FTM scans that an AP, e.g., AP 302, should perform for each of its neighbors APs. Alternatively, minimum neighbor scan time can be used to set a threshold number of FTM scan results that the AP should fetch/request, after which the AP stops transmitting FTM scan requests to a particular neighbor AP.

Some examples of the disclosed technology may leverage some, but not necessarily all of the specified FTM scan parameters. For example, location service 300 may not necessarily specify a particular radio power at which a dedicated radio should transmit packets/frames, in which case, the dedicated radio(s) may attempt to perform FTM scanning at maximum power.

The channel list loop number can be used to indicate the FTM scan iteration being performed by an AP, e.g., AP 302. That is, AP 302 can progress through a plurality of channels (in the given order) by performing an FTM scan on a first channel of the ordered channel list. Once FTM scanning (in accordance with the other, noted scan parameters) is complete, AP 302 can commence FTM scanning on a second channel of the ordered channel list, and so on.

It should be noted that other “actions” can be undertaken by AP 302. Location service 300 can specify such actions/control what AP 302 is to do via the scan parameters. For example, location service 300 may specify in its FTM scan parameters, that upon FTM scanning being completed, AP 302 should, e.g., either wait, end, perform a rescan, or perform some other action(s). AP 302 can be instructed to perform a desired action(s) during some state(s) of an FTM session instead of only when FTM scanning completes.

At operation 306, AP 302 may put one or more of its radios into a dedicated FTM scanning mode. As described above, an AP, such as AP 302, may comprise one or more radios. One or more of AP 302's radios can be dedicated to FTM scanning, the performance of which may be executed in accordance with the FTM scan parameters that were transmitted by location service 300 to AP 302. For example based on the ordered channel list, AP 302 can tune or configure one or more of its radios to operate on the channels set forth in the ordered channel list, and the specified channels can determine which of its radios should be dedicated to FTM scanning for a given FTM session. The manner in which radios are dedicated can be controlled by the requesting application/service (e.g., location-based service) or an AP controller, e.g., AP controller 104 of FIG. 1. That is, such a service or controller may exert its control over each radio separately. For example, a location-based cloud service in need of determining AP location(s) can create or initiate separate dedicated FTM sessions on a per-radio basis (as opposed to on an AP basis, recalling that an AP, such as AP 302 may comprise multiple radios/radio chains). Accordingly, a unique or different session_id can be created and associated with each radio, such that a first AP radio may be dedicated to FTM scanning for a particular FTM scanning session (over a first channel), while a second AP radio may be dedicated to FTM scanning for another FTM scanning session (over a second channel). Each FTM scanning session may have different FTM scan parameters according to which FTM scanning is performed, e.g., different channel lists. In accordance with other examples of the disclosed technology, multiple radios, e.g., two radios of an AP can be dedicated to FTM scanning, and switched to a particular radio band (2G, 5G, 6G). Thus, provided an AP radio can switch to, and operate over another band than that provided in the FTM scan parameters, the AP can switch the radio band on which the two radios are operating, and then commence FTM scanning.

Accordingly, at operation 310, AP 302 can tune its dedicated radio(s) to the first channel of the received ordered channel list, where the ordered channel list is one of the FTM scan parameters. If that channel is supported, the dedicated radio can remain. If that channel is not supported, the dedicated radio may remain on its current channel of operation. That is, different APs, or models of APs can have different supported channel lists because APs may be subject to indoor/outdoor specifications or use, or APs may be bound by FCC certification or other regulation or standard. Thus, if an AP does not support a particular channel set forth in the received ordered channel list because operation on that particular channel will violate some operational restriction, the dedicated radio may remain on its current channel.

AP 302 may transmit a radio mode notification at operation 308 back to location service 300 to inform location service 300 that at least one radio of AP 302 has been put into a dedicated FTM scanning mode of operation. This notification can be forwarded by location service 300 to other location-based services or applications so that those other services/applications can stop relying on/using the at least one dedicated radio of AP 302.

Location service 300 can subscribe to FTM measurement data reports sent by AP 302 so that it receives such FTM measurement reports.

As discussed above, FTM scan parameters can include an FTM scan start time indicating to the AP, e.g., AP 302, when its dedicated radio(s) should or can begin FTM scanning. Accordingly, AP 302 can wait for such a start time at operation 314. For example, AP 302 may send a burst of action frames to location service 300. The action frames can be acknowledged by location service 300. Hardware on which location service 300 is running, and AP 302 hardware can mark TOA and TOD of the action frames and their corresponding ACKs. Location service 300 may then collect the TOA/TOD information for all action frame and ACK pairs to calculate RTT. The results can be averaged.

It should be understood that a specified timing sequence keeps the dedicated FTM scanning radio(s) of APs, such as AP 302, operative on the same channel, and starting FTM scanning at the same time.

In the event that a channel on which a dedicated radio of AP 302 is to perform FTM scanning happens to be a DFS channel, AP 302 can wait the requisite CAC time period at operation 316. AP 302 can also wait a given amount of time to update neighbor information at operation 318. Normally, operation on a DFS channel requires a device to wait for the requisite CAC time before the DFS channel becomes available. However, if zero-wait-dfs function is enabled on AP 302, AP 302 can monitor a next DFS channel set forth in the ordered channel list in advance. In this way, AP 302, can save time (the amount of time to comply with the CAC wait time) by monitoring for radar signals on the DFS channel before tuning to that DFS channel. If a dedicated radio(s) of AP 302 happens to be on a DFS channel, and encounters a radar signal, AP 302 can select a new channel, e.g., a next channel in the ordered channel list, and tune to that next channel immediately. If no other channel is available after radar detection, because the dedicated radio normally needs wait for, e.g., at least 30 minutes, AP 302 can execute a provided action sequence or abort FTM scan session by default.

If the CAC time in a particular region or jurisdiction (e.g., in European countries), exceeds one minute, DFS channels may simply be excluded from the ordered channel list. That is, if a CAC time exceeds what is reasonable for a particular scenario, FTM scanning is avoided on those channels associated with the excessive CAC times.

At operation 320, AP 302's dedicated radio(s) can commence performing FTM scans at a high frequency. Again, the FTM scan parameters can govern or control how FTM scanning is to be performed. For example, scan-duration and other parameters can be used to customize the details of an FTM scan operation. Examples of the disclosed technology contemplate performing FTM scanning often/with high frequency. In this context, high frequency FTM scanning can refer to the number of FTM scans being performed. As noted above, a disadvantage of conventional FTM scanning is that it is typically performed as a background process, which can refer to more infrequent scanning of neighbor APs. In contrast, and because radios can be dedicated to FTM scanning as described herein, the number of FTM scans that can be performed can be increased.

In some examples, the following algorithm can be used to determine a dwell time that covers the scan durations for each channel, and considering offset. It should be noted that offset can be yet another FTM scan parameter that may be specified and taken into consideration when performing FTM scans. It should also be noted that in some examples, this offset can be derived from the “EachScanDuration” and dwell time parameters, rather than being specified/configured separately. Regarding the following algorithm, it should be understood that the 802.11 WLAN standard specifies using a shared medium to transmit packets so that only one device is transmitting data at one time in a heard range (meaning the range of frequencies over which neighbor AP transmissions can be detected). Typically, when multiple 802.11 devices are sending signals at the same time in the heard range, a collision occurs. Thus, the time at which FTM scan requests are transmitted should be scattered or staggered to avoid such collisions. The below algorithm can achieve more evenly-balanced FTM scan request trigger times, and limits the maximum wait time that an AP should wait to receive an FTM response to an FTM scan request.

$$ActualDuration = EachScanDuration + random ( 0 , offset )$$

Once FTM scanning is complete for a given channel, AP 320 may transmit a corresponding measurement report at operation 322 to location service 300. Because FTM scanning is being performed frequently, conventional FTM reporting may not be suitable for reporting that amount of information, e.g., measurement data, captured in accordance with examples of the disclosed technology. Accordingly, high frequency publication of measurement data can be effectuated. With shorter delays in transmitting measurement reports, e.g., at operations 322 and 328, near-real-time reporting can be achieved. In other examples, AP 302 can report FTM data in a timely manner by way of telemetry events. That is, FTM measurement data can be reported once some threshold amount of data has been collected or in accordance with some specified reporting frequency.

To the above, it should be understood that during FTM scanning, APs collect a relatively large amount of measurement data that is reported to the service, controller, etc. This reporting can be regarded as being a telemetry message which is sent because APs are typically embedded devices that have limited memory. Accordingly, APs tend to send reports to offload this data so that the AP can capture/receive more measurement data in, e.g., a subsequent dedicated FTM scan session. Thus, examples of the disclosed technology utilize certain mechanisms to ensure that this exchange of data is performed efficiently, and avoids the undesirably scenario where multiple APs send their respective reports at the same time.

In some examples of the disclosed technology, AP 302 may keep measurement reports data stored in, e.g., an FTM result table. When that FTM result table becomes full, the oldest result can be aged out, and the FTM result table can be updated with new data. In other examples, older data may nevertheless be maintained, e.g., kept in measurement reports for some amount of time, or in accordance with a specified number of measurement reports that are transmitted. For example, it can be specified that measurement data be submitted in specified number of measurement reports before the measurement data can be discarded. This can mitigate or negate the impact of data being lost during transmission. The above scenarios can be controlled or specified by creating small report intervals, adding random delays for each AP to comply with before transmitting its report. In other examples, AP reporting can be initiated in accordance with trigger messages, where the size or amount of collected data (e.g., if the size/amount reaches a specified threshold) can be assessed and used as a basis (or justification for the immediate transmission of a report). Connection stability can be another factor or condition upon which AP reporting frequency or timing can be based, as can a sent minimum threshold number of times that an AP may send the same data (with respect to the aforementioned retention of older data). In this way, an AP may end up sending one copy of its collected data only, if a connection is stable (providing confidence that the collected data was likely received/not corrupted during transmission). In still other examples, an AP can report the state of a current FTM scanning session to the requesting service or its controller, and the requesting service/controller can determine when/how frequently the AP should send its report.

Again, an AP's radio may perform FTM scanning on successive channels identified in the ordered channel list received as part of the FTM scan parameters from location service 300. Thus, at operation 324, AP 320 can select the next channel in the ordered channel list to which the dedicated FTM scanning radio(s) can be tuned. At operation 326, the dedicated radio(s) of AP 302 may perform FTM scanning on the new channel, and at operation 328, may transmit a corresponding measurement report to location service 300. This can repeat as needed until FTM scanning has been performed on the channels specified in the ordered channel list.

At operation 330, FTM scanning may end (once FTM scanning is complete on all the channels of the ordered channel list, provided FTM scanning could be performed on all the channels), and the previous radio configuration can be re-applied to the dedicated radio(s). In this way, the dedicated radio(s) can be “released” from FTM scan responsibility. A new radio mode notification can be sent at operation 332, the notification indicating the dedicated FTM scanning has been completed. It should be noted that if FTM scanning cannot be completed, the current FTM scan session may be canceled. Optionally, the time/clock mechanisms of respective APs in a deployment or APs that are neighbors of one another (and hence subject to/involved in FTM scanning), can be synchronized to ensure accuracy in the timing/distance measurements. It should also be noted that an FTM scan session can be defined on a per-dedicated radio basis, allowing for more fine-grained control of the FTM scanning process or operations (as opposed to an entire AP-based FTM scanning process, where multiple radios can be affected or impacted by, e.g., FTM scan parameters, network conditions leading to canceled FTM scan sessions, and so on).

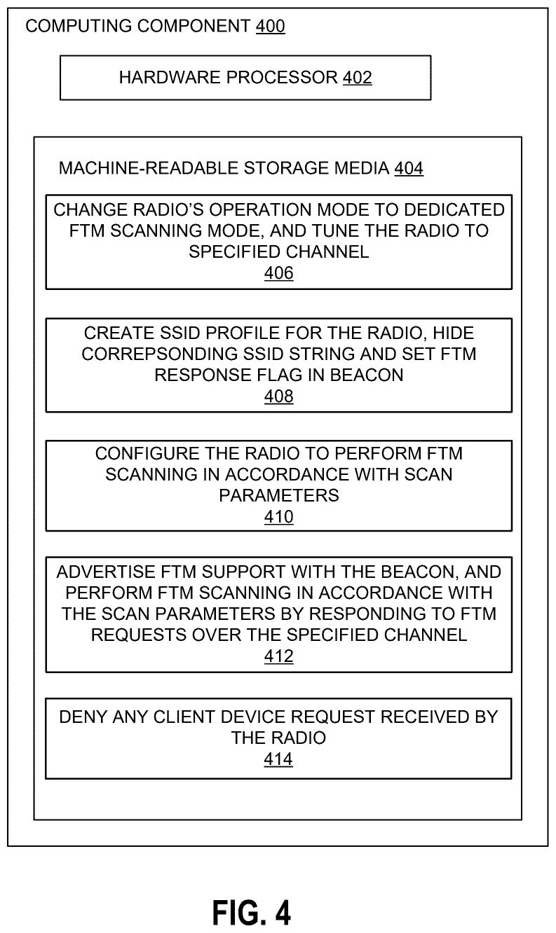

FIG. 4 illustrates a computing component that may be used to implement optimized/improved FTM scanning in accordance with various examples of the disclosed technology. Referring now to FIG. 4, computing component 400 may be, for example, a server computer, a controller, or any other similar computing component capable of processing data. In the example implementation of FIG. 4, computing component 400 includes one or more hardware processors 402, and machine-readable storage medium 404.

Hardware processor 402 may be one or more central processing units (CPUs), semiconductor-based microprocessors, and/or other hardware devices suitable for retrieval and execution of instructions stored in machine-readable storage medium 404. Hardware processor 402 may fetch, decode, and execute instructions, such as instructions 406-414, to control processes or operations for FTM scanning. As an alternative or in addition to retrieving and executing instructions, hardware processor 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating signals. As described in detail below, machine-readable storage medium 404 may be encoded with executable instructions, for example, instructions 406-414.

In some examples, computing component 400 may be an embodiment of an AP, such as AP 302 or APs 106A-C.

Hardware processor 402 may execute instruction 406 to change a radio's operation mode to a dedicated FTM scanning mode, and tune the radio to a specified channel. As discussed above, examples of the disclosed technology can optimize FTM scanning by having APs dedicate one or more of their radios to perform FTM scanning in accordance with one more scan parameters specifying the manner in which FTM scanning is to be performed. When dedicated to FTM scanning an AP's radio(s) will no longer provide client device access/support communications for the duration of the FTM scanning session(s).

Hardware processor 402 may execute instruction 408 to create an SSID profile for the radio, hide a corresponding SSID string, and set an FTM response flag in a beacon. As noted above, an SSID can be considered the name or ID of a network, and is typically used by devices, e.g., client devices, seeking to find and connect to the network. APs can broadcast beacons that include their SSID. Creating an SSID profile for the radio that is now dedicated to FTM scanning divorces the dedicated radio from other radios/network for communications purposes. Moreover, hiding the SSID string in an advertising beacon further prevents the dedicated radio from involvement in providing communications to client devices by virtue of client devices not being able to identify the dedicated radio's associated SSID. This allows the dedicated radio to perform FTM scanning only. Setting the FTM response flag in its beacon allows the AP to publish or advertise that it supports FTM as an FTM responder.

Hardware processor 402 may execute instruction 410 to configure the radio to perform FTM scanning in accordance with scan parameters. When creating/initiating an FTM session, the AP can receive one or more scan parameters, such as dwell time, scan duration, radio power, channel width, channels over which FTM scanning is to be performed, etc. Such FTM scan parameters set forth operating conditions or specifications accordance to which FTM scanning is to be performed. Accordingly, the transmit power of the radio can be set, an initial channel to which the radio is to be tuned can be set, and so on. Such FTM scan parameters, as described above, allow the performance of FTM scanning in accordance with examples of the disclosed technology to be tuned, optimized, or otherwise conditionally-controlled as desired to, e.g., facilitate high-frequency FTM scanning, increase the probability of successful FTM scanning/location determination, etc.

Hardware processor 402 may execute instruction 412 to advertise FTM support with the beacon, and perform FTM scanning in accordance with the scan parameters by responding to FTM requests over the specified channel. Again, an FTM initiator, e.g., a location service, client device, or other AP, can send an FTM ranging request, and the dedicated radio can respond, and ultimately, as described above, the distance between the location service/client device/other AP can be calculated based on the timing of receipt/transmission (TOA/TOD) of the FTM request/response.

Hardware processor 402 may execute instruction 414 to deny any client device request received by the radio. In accordance with dedicating at least one radio for the performance of FTM scanning, client device requests (other than FTM ranging requests) can be denied. As discussed above, the SSID associated with the dedicated radio can be hidden, which can pre-emptively avoid client devices sending non-FTM ranging requests to the dedicated radio. Hiding the SSID can be accomplished in some examples by not populating the SSID string field in an 802.11 beacon or probe response frame. That is, the SSID field will have a length of “0.” Thus, the hidden SSID will not appear pursuant to a request for identifying heard wireless networks.

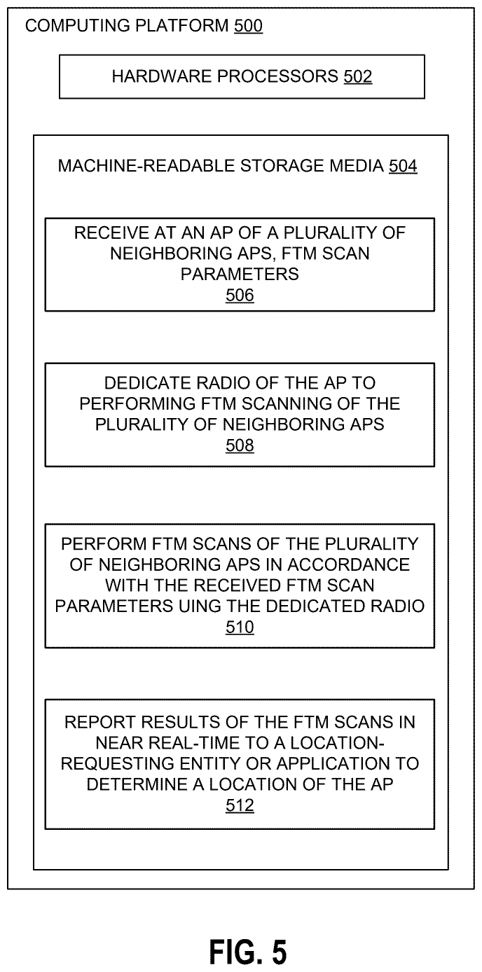

FIG. 5 illustrates a computing component that may be used to implement optimized/improved FTM scanning in accordance with various examples of the disclosed technology. Referring now to FIG. 5, computing component 500 (like computing component 400) may be, for example, a server computer, a controller, or any other similar computing component capable of processing data. In the example implementation of FIG. 5, computing component 500 (again like computing component 400) includes one or more hardware processors 502, and machine-readable storage medium 504. Hardware processor 502 may fetch, decode, and execute instructions, such as instructions 506-512, to control processes or operations for FTM scanning. As described in detail below, machine-readable storage medium 504 may be encoded with executable instructions, for example, instructions 506-512.

In some examples, computing component 50 may be an embodiment of an AP, such as AP 302 or APs 106A-C.

Hardware processor 502 may execute instruction 506 to receive, at an AP of a plurality of neighboring APs, FTM scan parameters. As discussed above, a location requesting entity, e.g., a location-based service, another AP, a client device, etc. may create an FTM session that is associated with a unique session ID. The location requesting entity may further send FTM scan parameters to the AP indicating one or more conditions or operating instructions according to which FTM scanning is to be performed by the AP.

Hardware processor 502 may execute instruction 508 to dedicate a radio of the AP to performing FTM scanning of the plurality of neighboring APs. As also discussed above, one manner in which the speed of FTM scanning can be increased, while mitigating its impact is to allow one or more AP radios to be dedicated to FTM scanning. Thus, FTM scanning need not be relegated to a “background” action or operation that exists along with actions/operations performed by the AP to provide communications connectivity to client devices, other background actions/operations, etc. One or more radios of the plurality of neighboring APs can be similarly dedicated to FTM scanning.

Hardware processor 502 may execute instruction 510 to perform FTM scans of the plurality of neighboring APs in accordance with the received FTM scan parameters using the dedicated radio. The FTM scan parameters specify the manner in which the dedicated radio/APs are to perform FTM scanning. FTM scan parameters can be used to dictate the amount of time an AP spends on a given channel (e.g., a channel specified in an ordered channel list that may be received as part of the FTM scan parameters). Other FTM scan parameters can indicate some minimum number of times the dedicated radio should perform FTM scanning, a power level at which the dedicated radio should transmit frames, and so on.

Hardware processor 502 may execute instruction 512 to report results of the FTM scans in near-real-time to a location requesting entity or application to determine location of the AP. As discussed above, the frequency with which FTM scanning is performed in accordance with examples of the disclosed technology, is higher than may be typically performed. In this way, and with shorter delays in transmitting measurement reports near-real-time measurement reporting can be achieved. As also discussed above, an AP can vary the manner in which it reports FTM measurement data, e.g., based on a threshold amount of collected measurement data, in accordance with some specified reporting frequency, etc.

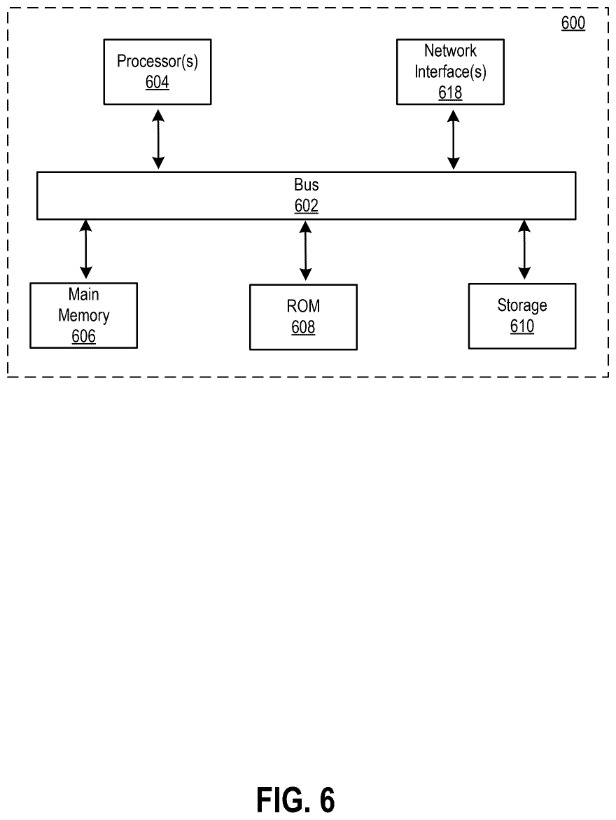

FIG. 6 depicts a block diagram of an example computer system 600 in which various examples of the disclosed technology described herein may be implemented. AP processors, location service processors/servers, network element processors discussed herein may be embodied as computer system 600. The computer system 600 includes a bus 602 or other communication mechanism for communicating information, one or more hardware processors 604 coupled with bus 602 for processing information. Hardware processor(s) 604 may be, for example, one or more general purpose microprocessors, circuits, etc.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution).

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606.

The term “non-transitory media,” and similar terms, as used herein refers to any media that store data and/or instructions that cause a machine to operate in a specific fashion. Non-transitory media is distinct from but may be used in conjunction with transmission media. Transmission media participates in transferring information between non-transitory media. For example, transmission media includes coaxial cables, copper wire and fiber optics, including the wires that comprise bus 602.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving at an access point (AP) of a plurality of neighboring APs, fine timing measurement (FTM) scan parameters;
dedicating a radio of the AP to performing FTM scanning of the plurality of neighboring APs;
performing FTM scans of the plurality of neighboring APs in accordance with the received FTM scan parameters using the dedicated radio;
reporting results of the FTM scans in near real-time to a location-requesting entity or application to determine a location of the AP.

2. The method of claim 1, wherein the FTM scan parameters comprise at least one of channel-related parameters, radio power-related parameters, and FTM scanning timing-related parameters.

3. The method of claim 2, wherein configuration of the FTM scan parameters facilitates optimal, high-frequency FTM scanning, such that a number of FTM scans performed by the dedicated radio exceeds a number of FTM scans that would have been performed via background FTM scanning with a non-FTM scanning dedicated radio of the AP.

4. The method of claim 2, wherein the FTM scan parameters are specified on a per-radio basis.

5. The method of claim 4, further comprising creating a unique session ID associated with the performance of FTM scanning by each dedicated radio across channels specified in an ordered channel list received as part of the FTM scan parameters.

6. The method of claim 5, further comprising determining if a channel of the ordered channel list comprises a dynamic frequency selection (DFS) channel.

7. The method of claim 6, further comprising monitoring the channel, in accordance with a specified amount of time commensurate with a channel availability check (CAC), for radar signals upon determining that the channel is a DFS channel in advance of the dedicated radio performing FTM scanning on the channel, and while the dedicated radio is performing FTM scanning on another channel listed before the channel in the ordered channel list.

8. The method of claim 7, further comprising waiting for the specified amount of time commensurate with the CAC if a current channel on which the dedicated radio is to perform FTM scanning, or immediately moving to a next channel of the ordered channel list upon discovery of radar signals on the current channel.

9. The method of claim 5, further comprising, determining if a channel of the ordered channel list comprises a channel that is unsupported by the AP, and allowing the dedicated radio to remain on its current channel upon determining that the channel is unsupported by the AP.

10. The method of claim 1, further comprising creating a service set identifier (SSID) for the dedicated radio.

11. The method of claim 10, further comprising hiding the SSID for the dedicated radio in beacons and probe response frames transmitted by the AP.

12. The method of claim 11, further comprising allowing a non-FTM scanning dedicated radio of the AP to provide or continue providing communications support for one or more client devices already associated to the AP via the non-FTM scanning dedicated radio.

13. The method of claim 12, wherein the one or more client devices are prevented from discovering the dedicated radio by virtue of the hidden SSID, thereby preventing one or more client devices' attempts to associate to the AP via the dedicated radio, attempts for authentication at the AP via the dedicated radio, and probe requests.

14. A system, comprising:
a processor; and
memory comprising instructions that when executed, cause the processor to:
change a radio's operation mode to a dedicated fine timing measurement (FTM) scanning mode, and tune the radio to a specified channel;
create a service set identifier (SSID) profile for the radio, hide a corresponding SSID string, and set an FTM response flag in a beacon;
configure the radio to perform FTM scanning in accordance with scan parameters;
advertise FTM support with the beacon, and perform the FTM scanning in accordance with the scan parameters by responding to FTM requests over the specified channel; and
deny any client device request received by the radio.

15. The system of claim 14, wherein the scan parameters comprise at least one of channel-related parameters, radio power-related parameters, and FTM scanning timing-related parameters.

16. The system of claim 15, wherein specified scan parameters facilitates optimal, high-frequency FTM scanning, such that a number of FTM scans performed by the radio operating in the dedicated FTM scanning mode exceeds a number of FTM scans that would have been performed via background FTM scanning with a non-FTM scanning dedicated radio of the system.

17. A network element, comprising:
a first radio;
a second radio;
a processor; and
memory comprising instructions that when executed, cause the processor to:
dedicate the first radio to performing high-frequency fine timing measurement (FTM) scanning for enabling a location of the network element to be determined by a location-requesting entity or application;
receive one or more FTM scan parameters;
perform the high-frequency FTM scanning using the first radio in accordance with the one or more FTM scan parameters; and
provide client device communication support with the second radio.

18. The network element of claim 17, wherein the FTM scan parameters comprise at least one of channel-related parameters, radio power-related parameters, and FTM scanning timing-related parameters.

19. The network element of claim 17, wherein the memory comprises further instructions that when executed, cause the processor to transmit measurement reports back to the location-requesting entity or application comprising per-channel FTM scanning results.

20. The network element of claim 19, wherein the instructions that when executed cause the processor to transmit the measurement reports, comprise further instructions that when executed cause the processor to optimize delivery of the measurement reports to the location-requesting entity or application in accordance with the high frequency at which the FTM scanning is performed.
